(19) United States
(12) Patent Application Publication
(10) Pub. No.: US 2026/0208966 A1
(43) Pub. Date: Jul. 23, 2026

(54) MATERIAL HANDLING COMPONENT AND DRIVE UNIT THEREFOR

(71) Applicant: Dematic Corp., Grand Rapids, MI (US)

(72) Inventor: Nicholas M. Thomas, Cedar Springs, MI (US)

(21) Appl. No.: 19/456,483

(22) Filed: Jan. 22, 2026

Related U.S. Application Data
(60) Provisional application No. 63/748,044, filed on Jan. 22, 2025.

(51) Int. Cl. B65G 39/12

(52) U.S. Cl. CPC B65G 39/12

(57) ABSTRACT

A drive unit comprising a housing supporting a plurality of driving surfaces arranged in a plane and configured to provide a conveying function, with the housing including a transmission to drive the driving surfaces, and the transmission being operable to couple to a motor to drive the driving surfaces. A material handling section includes a platform having a plurality of receptacles with drive units in at least selected ones of the receptacles. The drive units may additionally be rotatable about a vertical axis to selectively orient a conveying direction of the driving surfaces.

### CROSS REFERENCE TO RELATED APPLICATION

The present application claims the priority benefit of U.S. provisional patent application Ser. No. 63/748,044 filed on Jan. 22, 2025, the disclosure of which is incorporated herein by reference in its entirety.

### TECHNICAL FIELD AND BACKGROUND

The present disclosure relates generally to material handling systems and, in particular, to a material handling component of a material handling system with drive units that can be configured to provide multiple handling functions, such as conveying, sorting, transferring, diverting and accumulating articles being transported on the material handling component.

Conveying systems typically include conveyor sections with a variety of conveying surfaces, such as provided by belts or rollers, and may incorporate diverter, sorter, transfer or accumulator components, such as articulating pushers or arms or pop-up rollers or belts or independently controlled rollers, to sort, transfer, divert, or accumulate articles being transported by the conveyor sections. In some applications, the conveying surfaces are separated to accommodate one of more these components. As a result of the increased spacing or simply as result of the characteristic of some articles, the spacing between the conveying surfaces of the conveyor sections may be too large. In other cases, the contact surface of the diverter, sorter, transfer or accumulator components may be too small to influence the movement of some packages.

### SUMMARY

Accordingly, the present disclosure describes a material handling component with a drive unit that can provide a conveying function and one or more other handling functions, such as sorting, diverting, transferring, or accumulating articles supported on the material handling component.

In one form, a drive unit includes a housing supporting a plurality of driving surfaces arranged in a plane and a transmission to drive the driving surfaces. The driving surfaces are configured to provide a conveying function and one or more other handling functions, such as sorting, diverting, transferring, or accumulating articles supported on the material handling component. The transmission is operable to couple to an internal or external motor to drive the driving surfaces. For example, the drive unit may be rotatable about a rotational axis orthogonal to the conveying direction of the conveyor section in which the drive unit is mounted to reorient the driving surfaces of the drive unit about the rotational axis. Alternately or in addition, the drive unit may include an internal timing gear for engagement by an internal or external motor to reorient the driving surfaces of the drive unit about a generally vertical axis.

In one aspect, the drive unit further includes a plurality of rollers, with the rollers forming the plurality of driving surfaces. Optionally, each of the rollers comprises a metal roller. Further, each of the rollers may comprise a metal roller with a texture or coating or layer to increase friction between the rollers and the articles being influenced by the drive unit.

In other aspects, the rollers each have a rotational axis and a roller length, with the roller lengths of at least two of the rollers varying from the roller lengths of the other rollers wherein the rollers have a non-rectangular footprint. In some applications, the rollers may all generally have the same lengths and, optionally, have a rectangular footprint.

In any of the above drive units, the transmission may include a pair of pulleys, and optional two pairs of pulleys, with each of the pair of the pulleys supporting a belt or loop, such as an O-ring, operable to frictionally engage and drive the plurality of driving surfaces. Further, the transmission may include belts to drive the pulleys. The belts may be parallel, diagonal or orthogonal to the loops.

In any of the above drive units, the housing may comprise a first housing portion and a second housing portion. The first housing portion includes the plurality of driving surfaces, and the second housing portion supports the transmission wherein the transmission is operable to transmit a driving force to the driving surfaces when the first housing portion is coupled to the second housing portion.

In one example, the first housing portion and the second housing portion may be configured to form a snap fit coupling therebetween. In other forms, the first housing portion and the second housing portion may be secured together by fasteners.

In other aspects, the transmission includes a driven shaft operable to couple to a motor to drive the driving surfaces. Optionally the driven shaft includes a toothed profile or driven gear for engagement by a timing belt or a drive gear to couple the driven shaft to the motor. The motor may be external or internal to the drive unit.

In yet another aspect, the driven shaft depends from the second housing portion and is operable to couple to a motor external from the drive unit.

In any of the above drive units, the housing comprises a cylindrical housing, for example, a cylindrical housing with a height H less than its diameter D.

In yet other aspects, any of the above drive units may further include a motor internal to the housing that is operable to (1) couple to the transmission or (2) rotate the drive unit about a rotational axis to reorient the driving surfaces of the drive unit about the rotational axis.

In other forms, a material handling component includes a platform with a plurality of openings and a drive unit in at least a select group of the openings. Each drive unit includes a housing supporting a plurality of driving surfaces arranged in a plane and a transmission to drive the driving surfaces. A motor is coupled to the transmission of at least one drive unit of the drive units to drive the driving surfaces of the at least one drive unit.

In one aspect, the motor is coupled to the transmissions of a group of the drive units via a belt or a gear to drive the driving surfaces of the group of drive units.

In other aspects, the motor comprises a first motor, and the group of the drive units comprises a first group of the drive units. The material handling component further includes a second motor, which is drivingly coupled to the transmission of another drive unit of the drive units wherein the driving surfaces of the first group of the drive units can be independently driven from the driving surfaces of the other drive unit. For example, the other drive unit may be a second group of drive units such that the driving surfaces of the first group of drive units can be independently driven from the driving surfaces of the second group of drive units.

In other aspects, at least a group of the drive units are rotatably supported in the platform about a rotational axis wherein the driving surfaces of the group of the drive units are operable to rotate about the rotational axis to reorient the driving surfaces of the group of the drive units.

For example, each drive unit of the group of the drive units includes a motor to rotate each drive unit about the rotational axis.

Alternately, each drive unit of the group of the drive units may include a timing gear that is operable to rotate each drive unit about the rotational axis and is engageable by a motor external to the drive units.

In any of the above material handling components, each drive unit may further include a plurality of rollers, which form the plurality of driving surfaces of each drive unit.

In any of the above material handling components, each transmission may include two pairs of pulleys, each of the pulleys supporting a belt or loop, such as an O-ring, operable to frictionally engage and drive the plurality of driving surfaces, such as the rollers, of the drive units.

In some forms, the openings may comprise circular openings, with the platform optionally including a recess, such as a recessed cup, extending from each of the circular openings to receive therein a respective drive unit of the drive units. In this manner the drive units may be simply dropped into the recesses via their respective openings. For example, each of the recessed cups has a transverse opening to receive a portion of each transmission of the drive units therethrough for engagement by a motor external to the drive unit.

For example, the housing of the drive unit many comprises a cylindrical housing, and further be formed from first and second housing portions—a base housing and then a base housing cover, which supports the driving surfaces.

In any of the above material handling components, each drive unit may further comprise a motor internal to the drive unit housing which is operable to rotate the each drive unit about a rotational axis to reorient the driving surfaces about the rotational axis of each drive unit.

In another aspect, a conveying system includes one or more of the above material handling components.

Accordingly, the present disclosure describes a material handling component with a drive unit, optionally a plurality of drive units, each with a plurality of driving surfaces that can provide a conveying function and one or more other handling functions, such as sorting, diverting, transferring, or accumulating articles supported on the material handling component, using one or more motors internal or external to the drive unit or units.

### BRIEF DESCRIPTION OF THE DRAWINGS

FIG. 1 is a perspective view of conveying system with side-by side material handling components each with a plurality of drive units in accordance with one or more embodiments of the disclosure;

FIG. 2 is a top plan view of the material handling components of FIG. 1;

FIG. 3 is an enlarged perspective view of an example drive unit of the material handling components;

FIG. 4 is top plan view of the drive unit of FIG. 3;

FIG. 5 is a side elevation view of the drive unit of FIG. 4;

FIG. 6 is another side elevation view of the drive unit of FIG. 4 rotated ninety degrees relative to the view of FIG. 5;

FIG. 7 is a perspective view of the drive unit of FIG. 3 with a top portion of the housing removed for clarity to show a transmission used to drive the driving surfaces of the drive unit;

FIG. 8 is top plan view of the drive unit of FIG. 7;

FIG. 8A is cross-section taken along line VIIIA-VIIIA of FIG. 8;

FIG. 9 is an elevation view of the drive unit of FIG. 8;

FIG. 10 is a side elevation view of the drive unit of FIG. 9;

FIG. 11 is another side elevation view of the drive unit of FIG. 9;

FIG. 12 is a bottom perspective view of the material handling components of FIG. 1 illustrating components of an external drive assembly in accordance with one or more embodiments of the disclosure that drive the driving surfaces of one or more drive units; and

FIG. 13 is an enlarged perspective view of detail XIII of FIG. 12.

### DETAILED DESCRIPTION

As will be more fully described below and in reference to the figures, the present disclosure describes a conveying system with one or more material handling components and a drive unit that can provide a conveying function and one or more other handling functions for the material handling component, such as sorting, diverting, transferring, or accumulating articles supported on the material handling component.

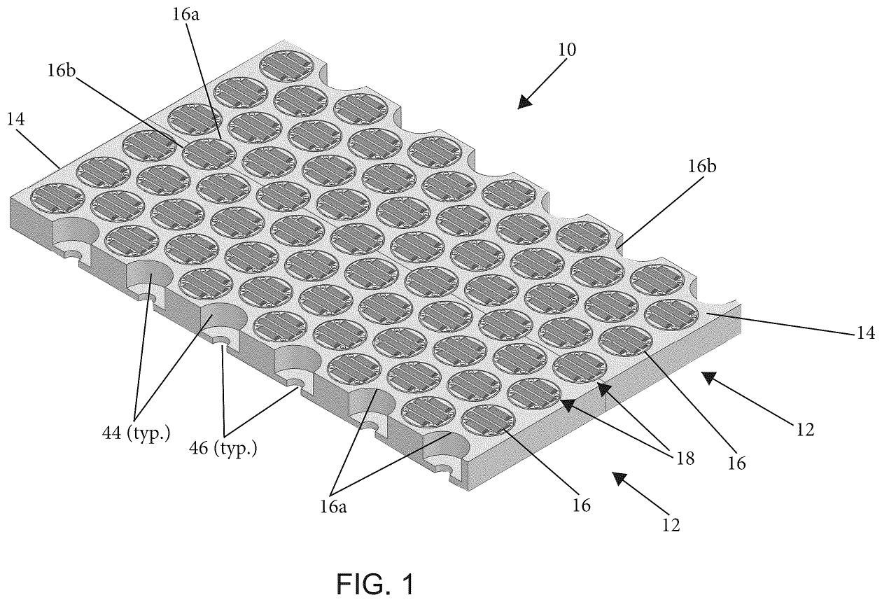

Referring to FIG. 1, the numeral 10 generally designates a conveying system, which is illustrated with two side-by-side material handling components or sections 12. Together the two side-by-side material handling components 12 form a conveyor section for conveying articles and may be configured to also provide one or more other handling functions, such as sorting, diverting, transferring, or accumulating articles supported on the respective material handling components. Although illustrated with two side-by-side material handling components, it should be understood that the conveyor section may include a single material handling component or more than two material handling components. Further, the material handling components may be used at spaced discrete locations in a conveying system interspersed between other conventional conveyor sections or components. However, to optimize the benefit of the drive units described more fully below, whole sections of conveying system may be comprised of material handling components 12.

Each material handling component 12 includes a platform 14 configured as a base with a plurality of receptacles having openings 16 for receiving a drive unit 18 in at least a selected group of the openings 16, and optionally in each opening as shown. The term “platform” is used broadly herein to include a raised planar surface, which may be horizontal or tilted. In the illustrated embodiment, openings 16 are circular openings, though it should be understood that other openings with other shapes may also be used, as will be more fully described below.

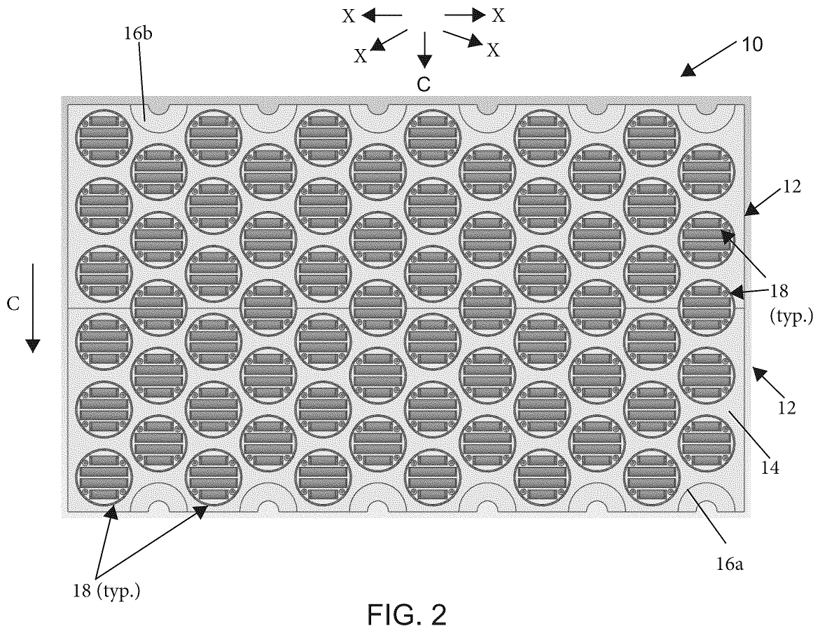

As discussed in more detail below, the drive units 18 are configured as compact drive cells that have convening surfaces and are moveable relative to platform 14, thereby providing flexibility in transporting items in various directions. Platforms 14 may be formed as a modular platform with openings 16 arranged in an array and, further, with partial openings 16a, 16b (e.g., semi-circular openings) along its edges in its edges that are perpendicular to the conveying direction C (arrow in FIG. 2) of the conveyor section formed by the material handling components. The partial openings 16a, 16b align with corresponding partial openings of an adjacent platform 14 to allow the drive units to be inserted therein when the adjacent platforms 14 are joined together using conventional fasteners or a snap fit construction, again as more fully described below, so that each opening may support a drive unit 18. For ease of description reference hereinafter will be made to one of the material handling components 12, with the understanding that the same or similar description may apply to the other material handling component 12 or components 12. Although shown with partial openings 16a, 16b, an alternative platform may be configured with scalloped edges such that there are no partial openings on a platform.

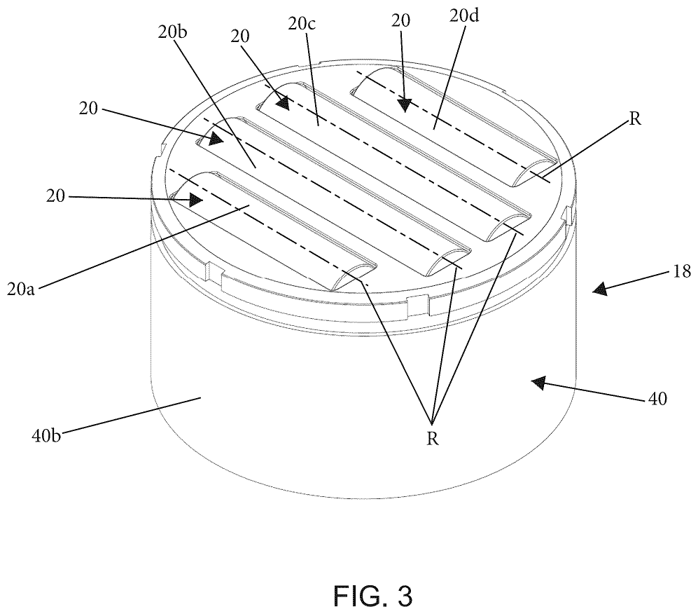

Referring to FIG. 3, each drive unit 18 includes a plurality of driving surfaces 20a, 20b, 20c, and 20d arranged in a plane and which provide the conveying surfaces and conveying function for articles supported on the material handling component, and as noted, one or more additional handling functions, such as sorting, diverting, transferring, or accumulating articles. The driving surfaces 20a, 20b, 20c, and 20d each provide a line contact conveying surface and are arranged in a parallel relationship to each other but are configured so that they can be reoriented as a group about a rotational axis that is perpendicular to their driven axes so that they can be transformed from providing a conveying function along a conveying direction (denoted by arrow C in FIG. 2) to another direction (see for example arrows X in FIG. 2) to provide another handling function (such as sorting, diverting, transferring). Further, depending on the size of the drive unit, the line contact may in some applications be greater than 120 mm or greater than 140 mm, which can increase the influence the drive unit can achieve on articles.

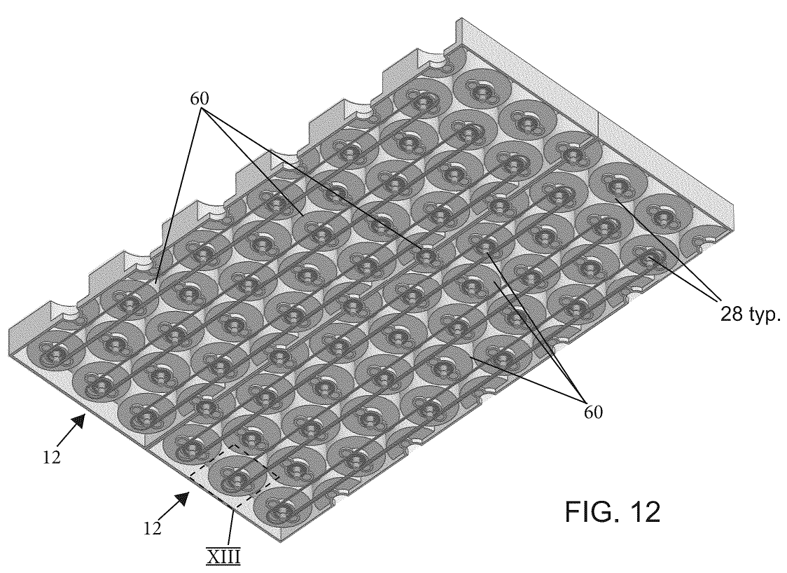

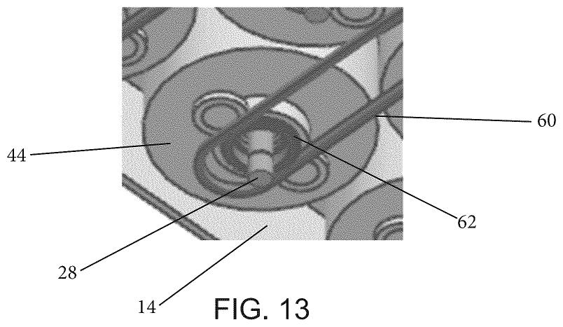

Alternately, because the drive units 18 may be individually controlled and/or controlled in groups (described below in reference to FIGS. 12 and 13), the speed of the driving surfaces 20a, 20b, 20c, and 20d between drive units 18 may be varied so that at least a group of the drive units 18 may have their driving surfaces 20a, 20b, 20c, and 20d slowed or sped up to provide an accumulator function.

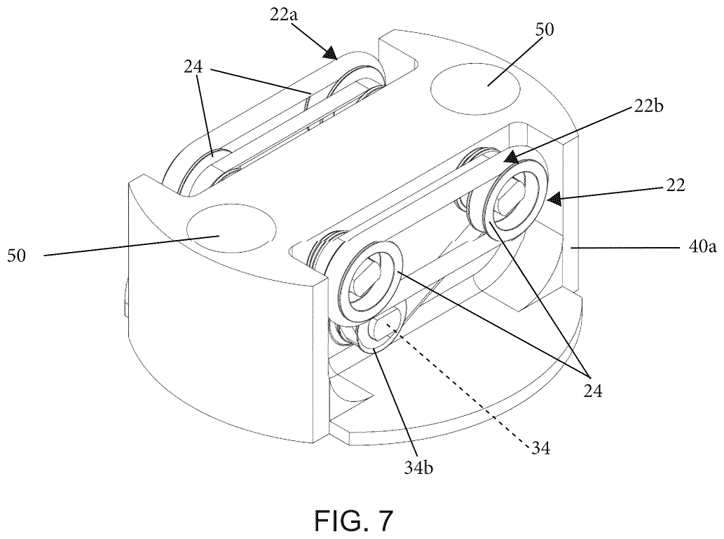

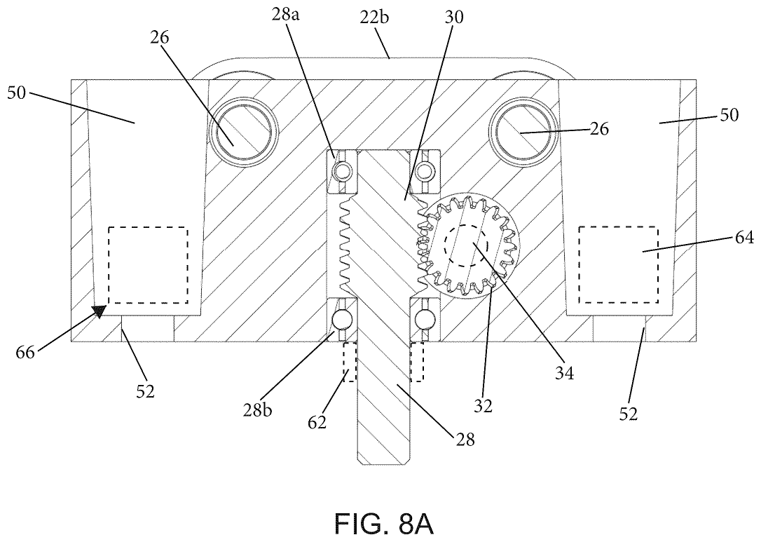

Referring to FIGS. 7, 8, 8A, and 9-11, driving surfaces 20a, 20b, 20c, and 20d may be formed by rollers 20, which are rotatably supported in drive unit 18 about their respective axes of rotation R. When rotated, the rollers 20, which project above the top of the drive unit housing and above the platform, can drive or push the articles supported on the material handling component.

To drive the rollers 20, and hence driving surfaces 20a, 20b, 20c, and 20d, each drive unit 18 includes an internal transmission 22 (that couples to an internal or external motor). Internal transmission 22 transmits power from a motor (as noted internal or external) to a pair of drive belts or loops 22a and 22b, such as O-rings, that frictionally engage rollers 20 to drive the driving surfaces 20a, 20b, 20c, and 20d of the drive unit 18.

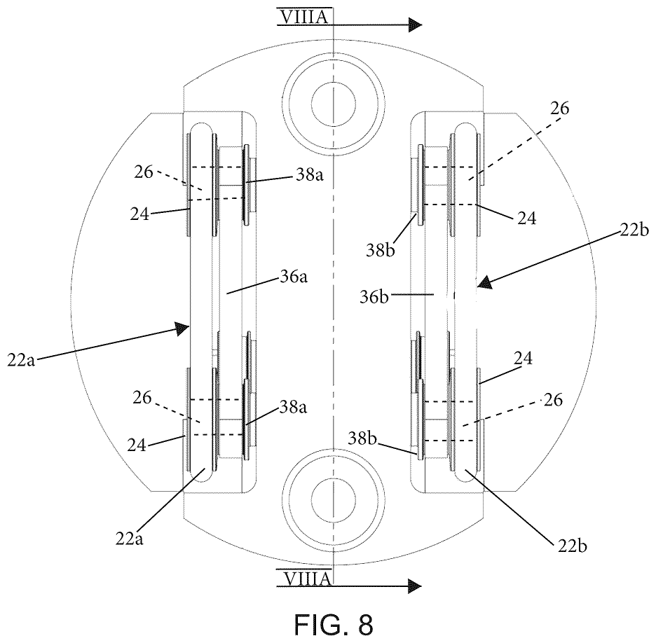

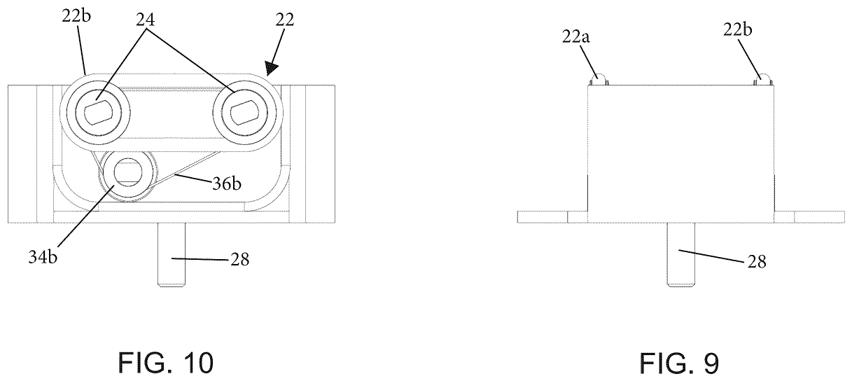

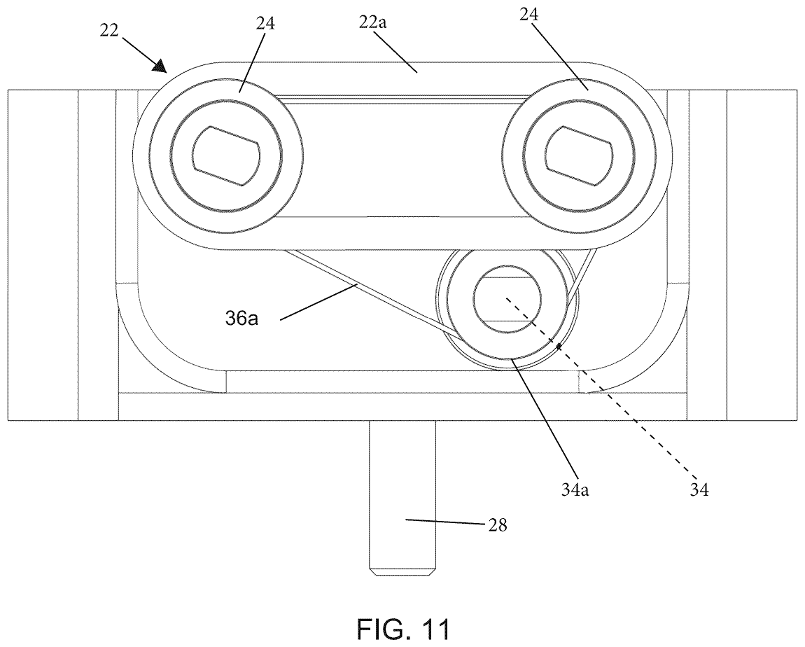

As best seen in FIGS. 7 and 8A, loops 22a and 22b are supported on pulleys 24, which in turn are mounted on shafts 26 (FIG. 7) and driven by a driven shaft 28 (FIG. 8A). Driven shaft 28, which is driven by an internal or external motor, is rotatably supported in drive unit 18 by upper and lower bearings 28a, 28b and includes a worm or worm gear 30 that engages and drives a worm gear wheel 32 to form a worm gear drive. The worm wheel 32 is mounted on a shaft 34, which supports two pulleys 34a, 34b (FIGS. 10 and 11), which in turn support two belts or loops 36a, 36b, such as belts, including timing belts, that engage the shafts 26 via pulleys 38a, 38b (FIG. 8), which transmit the power from the motor to shafts 26 to thereby drive the loops 22a, 22b to drive the rollers 20 and, hence, drive driving surfaces 20a, 20b, 20c, and 20d.

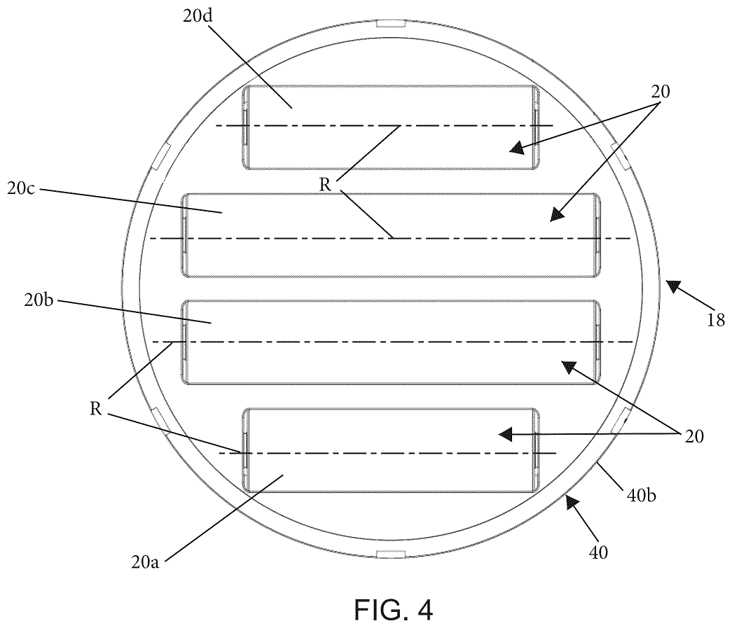

Referring again to FIGS. 4-8, each drive unit 18 includes a housing 40. Further, housing 40 may comprise a housing assembly formed from two or more housing portions, such as a base 40a, which supports the transmission 22, and a cover 40b, which supports the driving surfaces. The cover 40b may be joined with base 40a by fasteners or joined together by a snap-fit coupling arrangement. For example, the snap-fit coupling may be formed by ramped surfaces formed on the inside of cover 40b that engage recesses or engagement structures formed on the base 40a in a manner to vertically and rotatably coupled the two housing components together so that drive unit 18 may be rotated as a unit within platform 14, as will be more fully described below. In addition, when fully assembled and coupled together, the rollers 20 are configured to compress against the belts or loops, which as noted above may comprise O-rings, to increase the friction therebetween and allow the power to be more effectively transmitted from the transmission to the rollers.

In some forms, the openings 16 of platform may comprise circular openings. Further, the platform optionally includes recesses, such as a recessed cup 44 (FIG. 1) forming the receptacles, extending from each of the openings 16 to receive therein a respective drive unit 18 of the drive units 18. In one embodiment, the drive units 18 may be simply dropped in the recessed cups 44. As noted, the drive units 18 are configured to rotate within the cups 44.

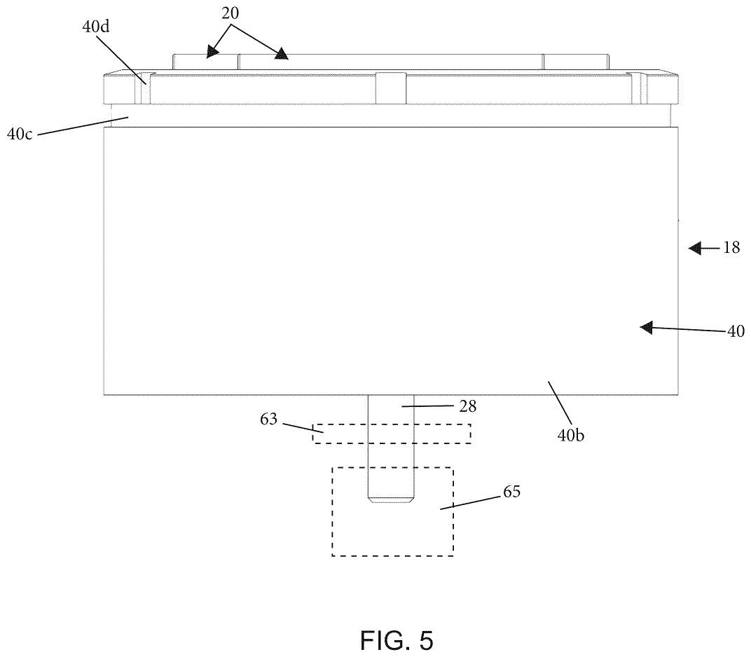

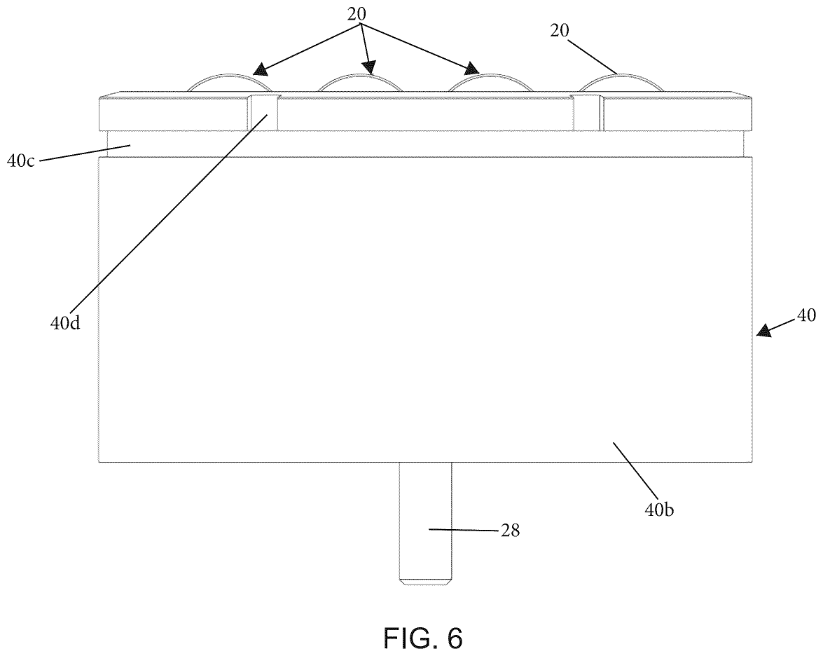

Alternately, each drive unit 18 may be pushed in the recessed cup 44 on a washer, a thrust bearing, and a wave spring, for example, with sufficient force to compress the wave spring to produce a pre-load on the drive unit 18. For example, the drive unit housings 40 may incorporate a channel 40c (FIGS. 5 and 6) that is engaged by a retaining ring that is used to hold the drive unit 18 in the recessed cup 44 when placed or inserted into the recessed cup 44. The retaining ring and channel 40c may be configured to produce the pre-load on the drive unit (e.g., by compressing the wave spring) so when a tool is used to disengage the drive unit 18 from the housing, the pre-load will help assist ejecting the drive unit 18 from the recessed cup 44. For example, the housing 40 may have one or more slots 40d (FIGS. 5 and 6) which allow a tool to disengage the retaining ring from engagement with the drive unit 18.

Further, each of the recessed cups 44 may have a transverse opening 46 to receive therethrough a portion of the respective transmissions of the drive units 18, such as the driven shafts 28. In this manner, when the drive units 18 are placed or pushed into the recessed cup, shafts 28 extend through and below recessed cups 44 for engagement by a motor (internal or external) to the drive unit either through a gear or belt, such as a timing belt.

Referring to FIGS. 5, 12 and 13, as noted above, the driving surfaces 20a, 20b, 20c, and 20d of drive units 18 may be individually driven or driven as a group or driven in multiple groups to achieve the desired function. For example, as understood from FIG. 5, each driven shaft 28 of the drive units 18 may be engaged with a motor 65, such as an electric motor, for selectively driving the transmission 22 and, in turn, the driving surfaces. Alternatively and/or additionally, driven shafts may be driven by a belt 63 (a partial belt 63 being shown in FIG. 5). For example, the driven shafts 28 of multiple drive units 18 may be connected together via belt 63, with belt 63 being driven to in turn rotate the driven shafts 28 of the engaged drive units 18. The belt 63 may be driven by a separate motor or belt 63 may be driven via motor 65. Belt 63 may directly engage with driven shaft 28 or driven shaft 28 may include a pulley or the like about which belt 63 is disposed. Further, one or more belts may each be driven by a motor so that several motors may be used to drive the driven surfaces 20a, 20b, 20c, and 20d of the various drive units 18. Consequently, the material handling component 12 may be configured to have driving units 18 in one row driven independently of another row of driving units 18 to form a dual lane conveyor section, for example. Alternately or in addition, rows of drive units 18 may be driven at different speeds to provide an accumulator function. Optionally, each drive unit 18 may be individually driven by providing a motor (internal or external) that engages each driven shaft 28, for example, by a gear that engages the toothed profile 62 on the driven shaft 28. It should be appreciated that various different configurations for driving the drive surfaces and drive units may be employed.

As noted above, each drive unit may be rotated about a vertical axis to reorient the drive surfaces 20a, 20b, 20c, and 20d such that the drive units 18 can divert, sort or transfer articles in a direction along an axis X (FIG. 2) that is angled relative to the flow direction C. For example, as best understood from FIG. 12, a group of drive units 18 that are arranged in a row may be rotated by an external motor via a belt 60, such as a timing belt, to rotate each drive unit 18 within that group of drive units 18. For example, the bottom of the housings 40 may be formed or provided with a toothed profile 62 (FIGS. 8A and 13) for engagement by the timing belt 60. Further, the belts 60 may be arranged so they are parallel, perpendicular or diagonal to direction of flow (arrow C in FIG. 2).

Alternatively and/or additionally, the driving of driving surfaces 20a, 20b, 20c, 20d and/or the rotation or turning of drive units 18 about their vertical axis may be achieved by providing internal motors within the drive units 18. For example, an internal motor 64 for each drive unit 18 may be operable to rotate each drive unit about a rotational axis to reorient the driving surfaces about the rotational axis of each drive unit. Additionally and/or alternatively, as noted, each drive unit 18 may have a motor 66 that drives the driven surfaces 20a, 20b, 20c, and 20d of the drive unit 18.

For example, the internal motor or motors (64, 66) may be supported and located in base 40a of housing 40, for example, in recesses 50 (FIGS. 7 and 8A) that extend through base. Recesses 50 may have transverse openings 52 to allow the motor drive shaft and drive gear of motors 64, 66 to extend below drive unit 18 to drive a gear or belt to drive either shaft 28 and/or a gear or belt to engage a toothed ring, for example, provided in platform 12 to rotate the drive unit 18 about its rotational axis.

The drive units may also have on board local controllers to control the motor or motors, which can then be controlled by a central control system via wires or wireless connections. In this manner, each drive unit may be individually controlled for rotation and, optionally, also to provide its conveying and other handling functions.

As noted, drive units 18 may be controlled by a central control system that may be configured with software to achieve the various handling functions described herein. The control system may be a microprocessor-based control system with a main controller that is implemented as hardware, software, firmware, and/or any combination of hardware, software, and/or firmware. The main controller may be implemented as one or more devices such as, for example, programmable processors (e.g., a field programmable gate array, a programmable logic controller), microprocessors (e.g., a central processing unit, a multi-core processor, a crypto processor, a digital signal processor, a graphics processing unit), microcomputers (e.g., an electronic control unit), microcontrollers, central processing units, state machines, and/or circuits (e.g., an analog circuit, a logic circuit, a crypto circuit, an application specific integrated circuit).

In any of the above material handling components, the platform and the drive unit housings may be formed, such as by molding. Further, the drive units may be easily and quickly installed or removed for repair or replacement.

Accordingly, the present disclosure describes a drive unit and a material handling component incorporating a plurality of the drive units that can provide multiple handling functions—conveying, sorting, diverting, transferring and accumulating—using a singe type of drive unit. The size of the drive unit may vary depending on its application. For example, the drive unit 18 may be constructed with 3-inch diameter housing for small applications such as for handling jiffies or poly-bags. The drive unit can incorporate an internal motor or motors so that it can be fully contained within the drive unit (except the overall control system) or may interface with one or more external motors. They can be arranged in rows to replace, for example, 2, 4, or 6 narrow belt systems (NBS) and, further be driven along the length of the material handling components. In addition, they can be arranged to provide simultaneous bi-directional diverting.

The embodiments of the invention in which an exclusive property or privilege are defined as follows:

1. A drive unit comprising:
a housing supporting a plurality of driving surfaces arranged in a plane, said driving surfaces being configured to provide a conveying function;
said housing including a transmission to drive said driving surfaces; and
said transmission operable to couple to a motor to drive said driving surfaces.

2. The drive unit according to claim 1, further comprising a plurality of rollers, said rollers forming said plurality of driving surfaces, and optionally each of said rollers comprising a metal roller, and further optionally each of said rollers comprising a metal roller with a texture or coating or layer to increase friction between said rollers and the articles being influenced by the drive unit.

3. The drive unit according to claim 2, wherein said rollers each have a rotational axis and a roller length, said roller lengths of at least two of said rollers varying from the roller lengths of the other rollers wherein said rollers have a non-rectangular footprint.

4. The drive unit according to claim 1, wherein said transmission includes a pair of pulleys, said pulleys supporting a loop, such as an O-ring, operable to frictionally engage and drive said plurality of driving surfaces.

5. The drive unit according to claim 1, wherein said housing comprises a housing assembly with a first housing portion and a second housing portion, said first housing portion including said plurality of driving surfaces, and said second housing portion supporting said transmission wherein said transmission is operable to transmit a driving force to said driving surfaces when said first housing portion is coupled to said second housing portion.

6. The drive unit according to claim 5, wherein said transmission includes a driven shaft operable to couple to a motor to drive said driving surfaces.

7. The drive unit according to claim 6, wherein said driven shaft depends from said second housing portion and is operable to couple to a motor external from said drive unit.

8. The drive unit according to claim 1, wherein said housing comprises a cylindrical housing.

9. The drive unit according to claim 1, further comprising a motor internal to said housing and being operable to (1) couple to said transmission or (2) rotate said drive unit about a rotational axis to reorient said driving surfaces of said drive unit about said rotational axis.

10. A material handling component comprising:
a platform having a plurality of receptacles;
a drive unit in at least a select group of said receptacles, each drive unit comprising:
a housing;
a plurality of driving surfaces supported by said housing and arranged in a plane; and
said housing including a transmission to drive said driving surfaces; and
a motor coupled to said transmission of at least one drive unit of said drive units to drive said driving surfaces of said at least one drive unit.

11. The material handling component according to claim 10, wherein said motor is coupled to said transmissions of a group of said drive units via a belt or a gear to drive said driving surfaces of said group of drive units.

12. The material handling component according to claim 11, wherein said motor comprises a first motor, said group of said drive units comprises a first group of said drive units, said material handling component further comprising a second motor, said second motor being drivingly coupled to said transmission of another drive unit of said drive units wherein said driving surfaces of said first group of said drive units can be independently driven from said driving surfaces of said other drive unit.

13. The material handling component according to claim 11, wherein said motor comprises a first motor, said group of drive units comprises a first group of drive units, said material handling component further comprising a second motor, said second motor being drivingly coupled to said transmissions of a second group of said drive units wherein said driving surfaces of said first group of drive units can be independently driven from said driving surfaces of said second group of drive units.

14. The material handling component according to claim 10, wherein at least a group of said drive units are rotatably supported in said platform about a rotational axis wherein said driving surfaces of said group of said drive units are operable to rotate about said rotational axis to reorient said driving surfaces of said group of said drive units.

15. The material handling component according to claim 14, wherein each drive unit of said group of said drive units includes a motor to rotate said each drive unit about said rotational axis.

16. The material handling component according to claim 14, wherein each drive unit of said group of said drive units includes a timing gear operable to rotate said each drive unit about said rotational axis and engageable by a motor external to said drive units.

17. The material handling component according to claim 10, wherein each drive unit further comprises a plurality of rollers, said rollers forming said plurality of driving surfaces of said each drive unit.

18. The material handling component according to claim 10, wherein each transmission of said transmissions includes two pairs of pulleys, each pair of pulleys supporting a loop, such as an O-ring, operable to frictionally engage and drive said plurality of driving surfaces of said drive units.

19. The material handling component according to claim 11, wherein said receptacles comprise circular openings to receive therein a respective drive unit of said drive units, and wherein each of said receptacles has a transverse opening to receive a portion of each transmission of said drive units therethrough, and wherein said housing comprises a cylindrical housing.

20. The material handling component according to claim 10, wherein each drive unit further comprises a motor internal to said housing of said each drive unit and being operable to rotate said each drive unit about a rotational axis to reorient said driving surfaces about said rotational axis of each drive unit.
